(19) United States
(12) Patent Application Publication
(10) Pub. No.: US 2024/0239032 A1
(43) Pub. Date: Jul. 18, 2024

(54) ENCLOSING THE BLOWING AREA OF A BIOPOLYMER BLOWN FILM PRODUCTION PROCESS

(71) Applicant: Plastic Suppliers, Inc. dba Earthfirst, Columbus, OH (US)

(72) Inventors: Tom Bowden, Columbus, OH (US); Ed Tweed, Columbus, OH (US)

(21) Appl. No.: 18/414,440

(22) Filed: Jan. 16, 2024

Related U.S. Application Data
(60) Provisional application No. 63/439,018, filed on Jan. 13, 2023.

(51) Int. Cl. B29C 48/00; B29C 48/14; B29C 48/285; B29C 48/797; B29C 48/92; B29C 55/28

(52) U.S. Cl. CPC B29C 48/0018; B29C 48/14; B29C 48/288; B29C 48/797; B29C 48/92; B29C 55/28; B29C 2791/005; B29C 2948/92209; B29C 2948/92333; B29C 2948/92704; B29C 2948/92828

(57) ABSTRACT

A system and method for enclosing the blowing area of a biopolymer blown film production process. The enclosure surrounds the blown film tower and includes at least a climate controller to maintain an optimal temperature for the blown film process.

### CROSS-REFERENCE TO RELATED APPLICATIONS

This application claims priority to U.S. Provisional Application No. 63/439,018 entitled “ENCLOSING THE BLOWING AREA OF A BIOPOLYMER BLOWN FILM PRODUCTION PROCESS”, filed Jan. 13, 2023, the entire contents of which are incorporated by reference herein.

### FIELD OF THE DISCLOSURE

The present disclosure is generally related to films produced by blown film processes. More specifically, the present invention relates a system and method for enclosing the blowing area of a biopolymer blown film production process.

### BACKGROUND

In recent years, interest in compostable polymers, i.e. biopolymers, has greatly increased, and many companies have made efforts to market, for example, packaging materials, hygiene products, sacks, and films with compostable polymers. Polylactic acid (PLA), i.e., polylactide, or condensation polymers, which are based on lactic acid are for many reasons a very attractive group of biopolymers. Their principal degradation product, lactic acid, is a product common in nature, it is not toxic and is used widely in the food and pharmaceutical industries. Films, particularly blown films, comprising biopolymers have proven difficult to manufacture. Some biopolymers (PLA, PBAT, PHA, etc.) are difficult to produce via a blown film process due to their tendency to wrinkle or develop other imperfections. This is primarily due to the collapsing temperature being too high or too low. Indeed, currently, available biopolymer blown films require the addition of additives such as plasticizers to enable their production.

However, plasticizers are often undesirable for films with food-related applications: they are costly, and they seldom, if at all, are as environmentally friendly as biopolymers themselves. To circumvent these issues, some manufacturers have resorted to manufacturing biopolymer films with casting methodology (e.g., cast and tenterframe). However, casting methodology produces films for limited applications. Accordingly, there is a need for biopolymer blown films substantially free of plasticizers to provide specific characteristics not available in a cast and tentered film. There is thus a need for a method of manufacturing biopolymer films using blown film processing.

### SUMMARY OF THE INVENTION

Provided herein are systems for producing a biopolymer blown film. The systems comprise an enclosure surrounding a biopolymer film bubble, the enclosure including one or more temperature sensors; and a climate controller in electrical communication with the one or more temperature sensors, the climate controller configured to increase or decrease a temperature within the enclosure. The enclosure may further surround an air ring, the air ring operable to blow air into the biopolymer film bubble. The enclosure may be insulated. The enclosure may further surround a collapsing frame within the enclosure and a plurality of primary nip rollers, wherein the collapsing frame and the plurality of primary nip rollers are located near a top of the enclosure and are operable to flatten the biopolymer film bubble into a double-thickness film. The climate controller may include a heating element operable to heat air, a cooling element operable to cool air, or a combination thereof. The system may further comprise a hopper in connection with an extruder operable to deliver biopolymer pellets to the extruder; the extruder operable to extrude the biopolymer through an annular die into the enclosure; and a biopolymer cooler operable to control the temperature of the extruded biopolymer prior to the formation of the biopolymer film bubble.

Further provided herein is a method for controlling the temperature in a system for producing a biopolymer blown film. The method includes inputting one or more temperature parameters corresponding to one or more zones in an enclosure of system; polling one or more temperature sensors for temperature data corresponding to the one or more zones; receiving the temperature data from the one or more temperature sensors; determining whether the temperature data is above or below the one or more temperature parameters; and outputting a control signal to increase or decrease the temperature of the one or more zones based on the temperature data.

Further provided herein are processes for producing a biopolymer blown film. The processes comprise blowing a biopolymer bubble in an enclosure, the enclosure comprising one or more temperature sensors operable to detect a temperature within the enclosure; comparing the detected temperature to a predetermined temperature; and increasing or decreasing the temperature of the enclosure when the detected temperature differs from the predetermined temperature.

### BRIEF DESCRIPTION OF THE DRAWINGS

FIG. 1 illustrates a biopolymer blown film production system.

FIG. 2 illustrates a method for processing user input relative a controller and temperature module.

FIG. 3 illustrates a method for polling for user input.

FIG. 4 illustrates a method for polling a temperature sensor.

FIG. 5 illustrates a method for processing sensor data.

FIG. 6 shows an example computing system that may implement various systems and methods discussed herein.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Provided herein is a climate or temperature-controlled enclosure surrounding a blown film tower for the production of biopolymer blown films. The enclosure keeps the film at a higher temperature and allows for controlled cooling during the critical process of collapsing the bubble. This eliminates the need for significant plasticizers which results in a product that is lower cost to produce, more compostable and desirable for customers.

The invention further provides for a more cost-effective manufacturing method or a larger range of products without the need for adding additives, i.e., plasticizers.

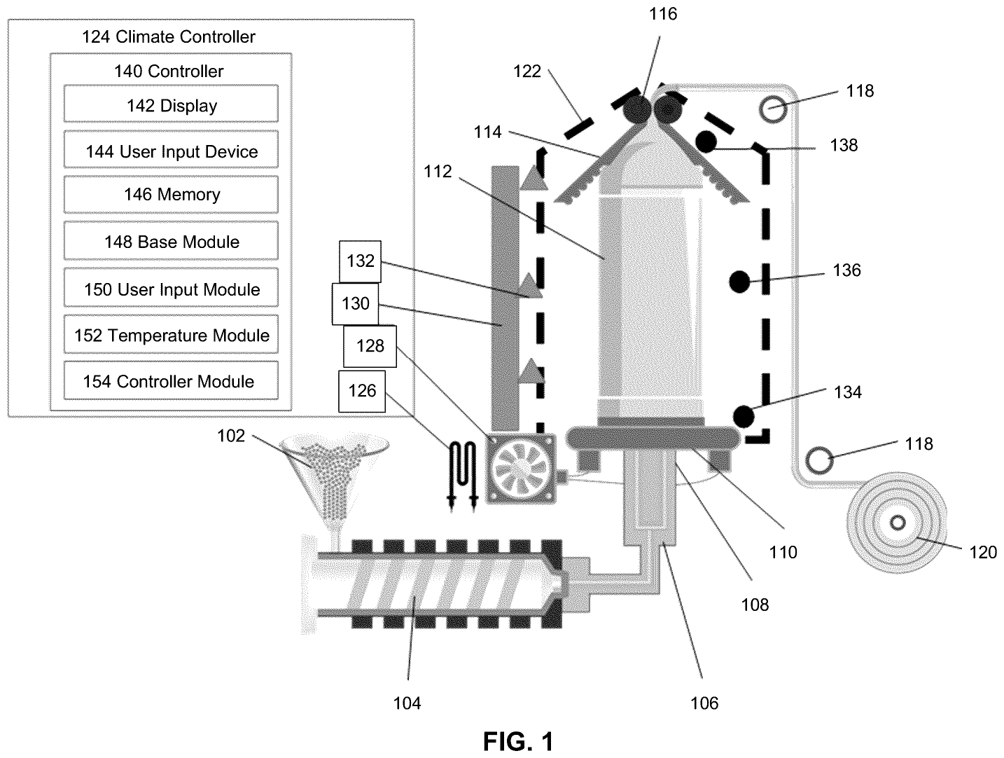

FIG. 1 illustrates a biopolymer blown film production system. This system comprises a hopper 102, which is a container for bulk material such as polymer pellets, which tapers down to a discharge point at the bottom where the bulk material is discharged into an extruder 104.

In one embodiment, the hopper 102 may include a dehumidifying element, such as an air dryer or a dehumidifying hopper using hot air at a relatively low dew point A variety of air dryers are known in the art and many of them may be suitable for drying in the systems described herein. The system need not be limited to air dryers only but may include other types of dryers, including baking or convection ovens. A dehumidifying hopper may be desirable in some embodiments in that dehumidified air passes through a bed of biopolymer to extract moisture from the biopolymer. The dehumidifying element may also include a desiccant bed. A desiccant material, such as silica, absorbs moisture from the circulating air. Dual desiccant bed systems are common and may be used in the systems described herein, so that one bed is on-stream while the stand-by bed is being regenerated. Either a time cycle or a predetermined decrease in air dew point may be used to shift airflow from one bed to the other. Such methodology may be effective in removing some moisture that may reside below the surface of the biopolymer pellets in addition to the surface moisture.

The extruder 104 receives bulk material, such as biopolymer pellets from the hopper 102. The extruder 104 then extrudes the material through an annular die 108. During the extrusion process, the pellets are melted and homogenized before they are pumped through the annular die 108. The pellets are melted into a low viscosity molten mass, thus combining the heretofore individual biopolymer beads or grains into one molten mass. The viscosity of the melt will depend on the temperature. Temperatures can range from about the temperature at which the polymers will remain melted to about the temperature where degradation of the polymers begins to occur. By way of example, extrusion melt temperatures may be maintained between about 325° F. to about 485º F for certain biopolymer blends, but may ultimately depend on the different polymers that have been blended and their respective melting points. In some embodiments, a temperature of about 400° F. may be preferred.

By way of example, the viscosity of biopolymers at about 480º F and an apparent sheer rate of about 5.5 seconds⁻¹ in a capillary rheometer may range from about 1,000 poise (P, dyne/cm2) to about 8,000 P, preferably from about 3,000 P to about 6,000 P, and more preferably, about 4,500 P. At a shear rate of about 55 seconds⁻¹, the same biopolymer at about 480° F. may have an apparent viscosity that ranges from about 1,000 P to about 5,000 P, preferably from about 2,000 P to about 4,000 P, and more preferably, about 3,000 P.

A biopolymer cooler 106 controls the temperature of the biopolymer to increase the viscosity of the molten biopolymers, which makes the melt manageable for further processing. The cooling allows for the temperature of the extruded biopolymer to drop to a level at which the corresponding viscosity is high enough to allow a bubble to be blown. The process of the present invention has at least one significant advantage in that a very controlled temperature—from the post extrusion temperature conditioning—can be achieved prior to the formation of a bubble. Furthermore, it is thought that by increasing the viscosity, a smoother film surface is generated as compared with a film surface generated without the biopolymer cooler 106. A smoother surface aids in the printing process that is performed in many end-use applications, such as, for example, labels.

The polymer cooler 106 may include any cooler (i.e., heat exchanger) known in the art. The cooling medium may include air, liquids, or a polymeric coolant. For example, the viscosity of the polymer melt may be adjusted, alone or in combination, for example, by air cooling the die inner mandrel through which the polymer film is blown, the use of viscosity enhancers, controlling the die temperature with air or liquids, or polymer coolers. Accordingly, the biopolymer cooler 106 may include an air cooler.

For some implementations, the biopolymer cooler 106 operating temperature range is preferably between about 280° F. to about 450° F. Higher temperatures may be used, but such higher temperatures may also contribute to the degradation of the polymer. The temperature and duration of cooling can again depend on both the amount of polymer being cooled and the film properties that may be desired. In an embodiment involving polystyrene cooling, the pressure in the primary loop is generally about 1000 psi to about 7,000 psi. The pressure in the same loop adjusted for PHA use may range from about 300 psi to about 4,000 psi.

In one example, the viscosity of PLA at 375° F. and an apparent sheer rate of about 5.5 seconds⁻¹ in a capillary rheometer, may range from about 15,000 P to about 17,000 P, preferably about 15,500 P to about 16,500 P, and more preferably, about 16,000 P. At a shear rate of about 55 seconds⁻¹ the same polymer at 375° F. may have an apparent viscosity that ranges from about 14,000 P to about 16,000 P, preferably about 16,500 P to about 15,500 P, and more preferably, about 15,000 P. The polymer cooling step can increase the viscosity from anywhere from about 2 to about 10 times that of the polymer coming out of the extruder.

The extruded biopolymers demonstrate a substantial increase in viscosity upon cooling in the biopolymer cooler 106, which cooling procedure, in part, is thought to allow for the subsequent blowing of the film. The viscosity of the biopolymers exhibits a consistent shear viscosity of a relatively large range of shear rates at any given temperature. The annular die 108 is used for the shaping of polymer products, such as in the pipe extrusion process, extrusion blow molding process, and blow film extrusion process. In this part of the system, the biopolymer melt is already pre-cooled, preferably in a biopolymer cooler 106, and then submitted to a blown film orientation process. However, the viscosity of the biopolymer melt may also be adjusted, alone or in combination, for example, by air cooling the annular die inner 108 mandrel, the use of viscosity enhancers, and liquid thermoregulation of the annular die 108. A blown film extrusion apparatus extrudes molten plastic polymer through an annular die 108 of circular cross-section and uses an air jet (not shown) to inflate a bubble comprising the same.

The parameters of the annular die 108 may range from 1:0.75 BUR (Blown Up Ratio) to about 1:7.0 BUR, and preferably, about 1:4 BUR in the cross-web direction. In the length (or machine) direction, annular die 108 parameters may range from about 1:1 drawdown ratio to about 1:300 drawdown ratio, and preferably, about 1:130 drawdown ratio. Collapsing temperatures of the present invention range from about 90° F. to about 180° F., and more preferably, about 140° F.

In the preferred embodiment then, by pre-cooling the melted polymer, only a final fine-tuning of orienting temperature is performed, where desired, during the orientation process. In other words, the greater share of temperature conditioning takes place before orienting and not during orienting. Where fine-tuning of the temperature is desired, it may be accomplished by a temperature-controlled air ring 110, which blows chilled air at the base of the bubble or by internal cooling. The air ring 110 is used to fine-tune temperatures at the base of the bubble.

As the molten polymer is extruded through the annular die 108, or a die of circular cross-section, an air jet is used to inflate a bubble 112. Once the extrudate has been inflated into a circular bubble 112, it then is “collapsed” into a double-thickness film. The collapsing process is performed by use of an “A-frame,” also known as a collapsing frame 114. The collapsing frame 114 uses primary nip rollers 116, panels, and/or flat sticks to flatten the bubble 112 into a sheet of double-thickness film. The sheets are ultimately cut and wound into two finished rolls of biopolymer film using winder rollers 120. The sheets of film may also be cut to the desired length. The sheets of film may also be cut to a desired length.

In one embodiment the primary nip rollers 116 may be placed and designed in such a way that they do not allow any air to pass through. In such an embodiment, the primary nip rollers 116 may be placed at the very top of the enclosure 122 when the system is oriented in an upward direction. By limiting air from escaping through the primary nip rollers 116, the internal temperature of the enclosure may be better controlled.

Secondary nip rollers 118 may be located downstream of the primary nip rollers 116 to assist with moving the film along the line. In another embodiment, additional nip rollers may be used to further assist in moving the film along the production line. The winder rollers 120, coils, or winds the collapsed film after coming through the secondary nip rollers 118.

The enclosure 122 is a casing or exterior shell outside that encloses the film blowing apparatus. In one embodiment, the enclosure is insulated and temperature is not controlled by any system, while in another embodiment the enclosure is not insulated and the climate within the enclosure 122 is controlled by a climate controller 124. In another embodiment there may be any combination of insulated or non-insulated enclosures with or with out climate controllers. The enclosure 122 encases the film blowing process from the annular die 108 up to the primary nip rollers 116. The enclosure 122 surrounds the blown film tower and includes at least a heating/cooling element 126 to maintain an optimal temperature for the film blowing process. In another embodiment, the enclosure 122 does not encase the entire film blowing process but begins just after the bubble 112 is formed and encases the film blowing process up to the primary nip rollers 116. In another embodiment, the enclosure 122 is separated into several zones where the temperature in each zone is monitored and controlled separately by different temperature sensors (134, 136, 138) and separate air ducts 130 and air vents 132.

The climate control system 124 is used to maintain optimal temperatures within the enclosure. The climate controller 124 includes one or more heating/cooling elements 126, one or more blowers 128, one or more air ducts 130, air vents 132, one or more temperature sensors (134, 136, 138), and a controller 140. The climate controller 124 is located outside of the enclosure 122. In another embodiment, the climate controller 124 may include other types of sensors other than temperature sensors such as, but not limited to, moisture/humidity sensors. In such embodiments, the climate controller 124 also controls the humidity or moisture levels within the enclosure 122.

The heating/cooling element 126 may include a heating electric coil, a radiator, a heat exchanger, a condenser, or other means of heating or cooling the air. In another embodiment, there are at least two heating/cooling elements 126, which would allow the climate controller 124 to control the temperature of the air moving to different sections of the enclosure. A heating/cooling element may be included for each temperature sensor to allow for individual control of the temperature to each section of the enclosure where each sensor is located.

The blower 128 is used to move heated or cooled air from the heating/cooling element 126 through the air ducts 130 and air vents 132 to different sections of the enclosure 122. In another embodiment, there are at least two blowers 128, or at least three blowers. For example, the system may include one blower 128 for each of the temperature sensors so that air can be individually forced or routed to the area of each temperature sensor. The blower may be any blower known to those having ordinary skill in the art. The air ducts 130 channel heated/cooled air from the heating/cooling element 126 and blowers 128 to different portions of the enclosure 122. This allows for heated or cooled forced air to be distributed and directed to different sections of the enclosure 122 to ensure ideal temperature control throughout the enclosure 122. The air vents 132 open from the air ducts 130 and help direct and regulate the airflow into the enclosure 122. The air vents 132 may be controlled by the controller 140 to help direct airflow by opening and closing the air vents 132 or direct the airflow. The controller 140 may be in electrical communication with the air vents 132. The air vents 132 may be operable to receive an electrical signal from the controller 140 to open or close the air vents 132.

The system includes one or more temperature sensors. A temperature sensor is an electronic device that measures the temperature of its environment and converts the input data into electronic data to record, monitor or signal temperature changes. There are many different types of temperature sensors known in the art which may be used in the systems of the present disclosure. Some temperature sensors require direct contact with the physical object that is being monitored (contact temperature sensors), while others indirectly measure the temperature of an object (non-contact temperature sensors).

A first temperature sensor 134 monitors temperature within the enclosure 122. In the embodiment shown in FIG. 1, the first temperature sensor 134 is one of at least three temperature sensors that are located at different points within the enclosure 122. In one embodiment, the first temperature sensor 134 is located just above the air ring 110 but before the bubble 112 is fully formed. The first temperature sensor 134 monitors the temperature within the enclosure 122 just above the air ring 110. The first temperature sensor 134 is operable to transmit a signal to the controller 140 corresponding to the temperature detected by the first temperature sensor 134. The monitored temperature is electrically communicated (e.g., wired or wirelessly, including WiFi, Bluetooth, or other transmission mediums) back to the controller 140 which uses the temperature data to regulate air temperature within the enclosure 122.

A second temperature sensor 136 monitors temperature within the enclosure 122. The second temperature sensor 136 is one of at least three sensors that are located at different points within the enclosure 122. In one embodiment the second temperature sensor 136 is located at a mid-point of the enclosure 122. In another embodiment where the enclosure 122 doesn't fully enclose the system down to the air ring 110 the second temperature sensor 136 may be located at a point just as the bubble 112 enters the enclosure 122. The second temperature sensor 136 monitors the temperature and the monitored temperature is electrically communicated (e.g., wired or wirelessly, including WiFi, Bluetooth, or other transmission mediums) back to the controller 140, which uses the temperature data to regulate air temperature within the enclosure 122 at the location of the second temperature sensor 136.

A third temperature sensor 138 monitors temperature within the enclosure 122. The third temperature sensor 138 is one of at least three sensors that are located at different points within the enclosure 122 along the film blowing process. In one embodiment the third temperature sensor 138 is located just before the primary nip rollers 116 just before the bubble 112 is collapsed. The third temperature sensor 138 monitors the temperature within the enclosure 122 just before the primary nip rollers 116. The monitored temperature is electrically communicated (e.g., wired or wirelessly, including WiFi, Bluetooth, or other transmission mediums) back to the controller 140, which uses the temperature data to regulate air temperature within the enclosure 122 at the location of the third temperature sensor 138.

The controller 140 includes a display 142, a user input device 144 or a user interface, and memory 146. The controller 140 is used to program and control the climate controller 124. Users may select pre-stored settings or enter in specific settings using the user input device 144 and the controller 140 then monitors the temperature data from the temperature sensors. Based on data received from the sensors, the controller 140 adjusts the heat or cooling and airflow entering the enclosure 122 by adjusting the heating/cooling element 126, blower 128, and air vents 132.

The display 142 displays data and user inputs. Displayed data may include, but are not limited to, sensor data such as temperature, blower or fan speeds, or other data related to the film blowing process. As used herein, the term “sensor data” may be used interchangeably with “temperature data” or “temperature sensor data”.

The user input device 144 or user interfaces are well known in the art and may include, but are not limited to, keyboards, touch screens, voice, or other connected devices such as smartphones or tablets.

The memory 146 is a device or system that is used to store information for immediate use in a computer or related computer hardware and digital electronic devices. The term memory is often synonymous with the term primary storage or main memory. The memory 146 stores data from the sensors and other devices connected to the film blowing process. Furthermore, the memory 146 stores user input information from the user input device 144, a preset configuration such as temperature ranges or thresholds, and executable code or modules.

The base module 148 controls climate controller 124 and is initiated when the system is started or when initiated by a user through the user input device 144. The base module 148 includes the user input module 150, the temperature module 152, and the controller module 154.

Once the base module 148 is initiated, it initiates the user input module 150. Inputs from the user input module 150 are then returned to the base module 148, at which point the temperature module 152 and controller module are initiated 154. These modules continue to run until a user shuts down the system or a command to stop, end, or shut down comes from the user input module 150.

The user input module 150 monitors the user input device 144 for user inputs. A user input may include, but is not limited to, one or more temperature parameters for the enclosure 122, a selection from a set of stored parameters, or a start or stop command. For example, a user may input specific temperature or temperature ranges that are to be maintained within the enclosure 122 at each temperature sensor (134, 136, 138).

The temperature module 152 is initiated by the base module 148. Once initiated, the temperature module 152 continuously polls each of the temperature sensors (134, 136, 138) for temperature data and sends the temperature data to the controller module 154.

The controller module 154 is initiated by the base module 148. The controller module 154 monitors the temperature that is received from the temperature module 152 and controls the climate controller 124. The controller module 154 continuously compares the received temperature data from the temperature module 152 with parameters received from and set by the user from the user input module 150. When temperature data from the temperature sensor(s) (134, 136,138) are outside the set parameters the controller module 154 increases or decreases the required heat or cooling from the heating/cooling element 126 which results in a change in temperature within the enclosure 122. The continuous change in temperature maintains optimal temperature conditions for the film blowing process.

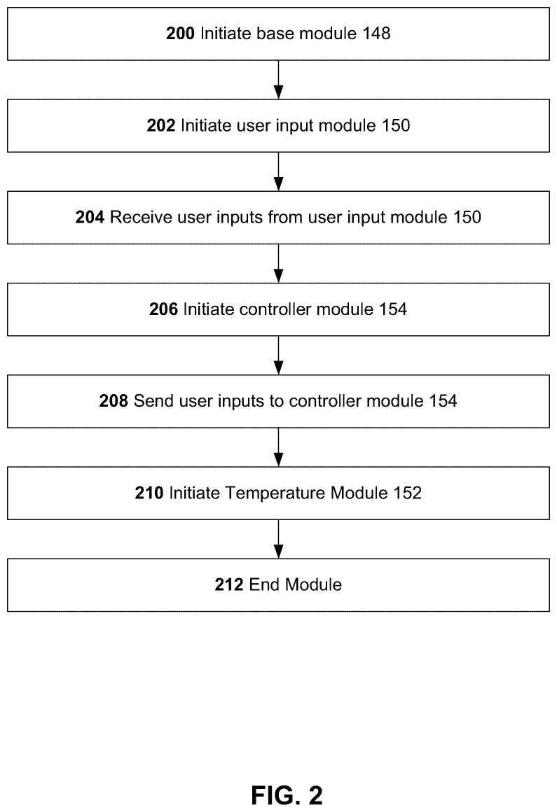

FIG. 2 illustrates a method for processing user input relative a controller and temperature module. The process begins at step 200 with the base module 148 being initiated when the system is started or when a user initiates the process, for example, when a system is turned on or when a user initiates the process through the user input device 144. At step 202, user input module 150 is initiated once the user input module 150 is initiated, which will allow users to start to input parameters or start the system. In other embodiments, the user input module 150 may already be initiated when the system is initiated. Once the user input module 150 is initiated, the user input module 150 prompts and receives user inputs from the user input device 144. At step 204, the user inputs are then sent to and received at the base module 148.

At step 206, the controller module 154 is initiated. The controller module 154 then begins to control specific environmental elements within the blown film process. In another embodiment, the controller module 154 may be initiated before or at the same time as the user input module 150 (i.e., at step 202). In yet another embodiment the controller module 154 may be used to control all aspects of the blown film process. For example, the controller module 154 may control both the environmental conditions within the enclosure 122 and may also control the speed of the film blowing process to ensure the highest quality. When environmental changes are identified within the enclosure 122 the system may speed up or slow down the blown film process for a short period as there is a possibility of a delay for environmental conditions to return to optimal conditions (i.e., temperature).

At step 208 after the controller module 154 has been initiated, the received user inputs from the user input module 150 are sent to the controller module 154. For example, the user inputs may be a selection from a list of preset parameters (i.e. temperatures) or a range of manually entered temperatures. At step 210 after the controller module 154 has received the user inputs from the user input module 150, the temperature module 152 is also initiated. In another embodiment, the temperature module 154 may be initiated at the same time as the controller module 154 (i.e., at step 206) or the user input module 150 (i.e., at step 202). Once the blown film process is completed or the system is shut down or a user input stops the system and process, then the base module ends 148 at step 212.

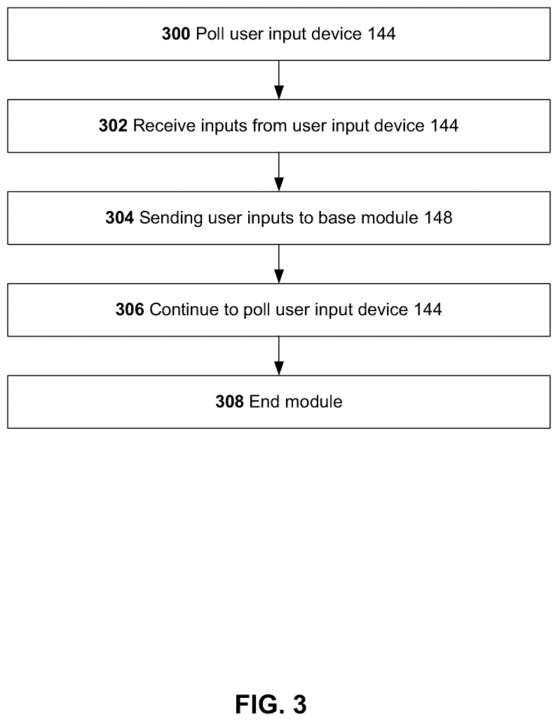

FIG. 3 illustrates a method for polling for user input. The process begins at step 300 with the user input module 150 polling the user input device 144 for any user inputs. User inputs may include, but are not limited to, a selection from a preset list of parameters (i.e., temperature ranges) or a manually entered set of parameters (i.e., temperature ranges). At step 302, the user input module 150 then receives from the user input devices 144 the user inputs. The user inputs may be a set or range of temperatures or a selection from a selection of preset parameters stored in memory 146. In one embodiment the user inputs may include but are not limited to, several different temperature ranges for each of the temperature sensors (134, 136, 138). In this embodiment, the temperature ranges may be slightly different at different zones or sections of the enclosure 122.

At step 304 after the user inputs are received, the user inputs are then sent to the base module 148, which then relays the inputs to the controller module 154. In one embodiment, if the user selects from a preset of parameters stored in memory 146, the user input module 150 would extract the individual parameters from memory 146. For example, the user may select preset parameters by entering in a number or character or a series of characters directly related to a set of parameters. These parameters are then extracted and sent to the base module 148.

At step 306, the user input module 150 continues to poll the user input device 144 for any new user inputs. For example, a user may change certain parameters or may put a command in to stop the process or system. At step 308, if the blown film system ends or a user inputs a command to stop, the module ends.

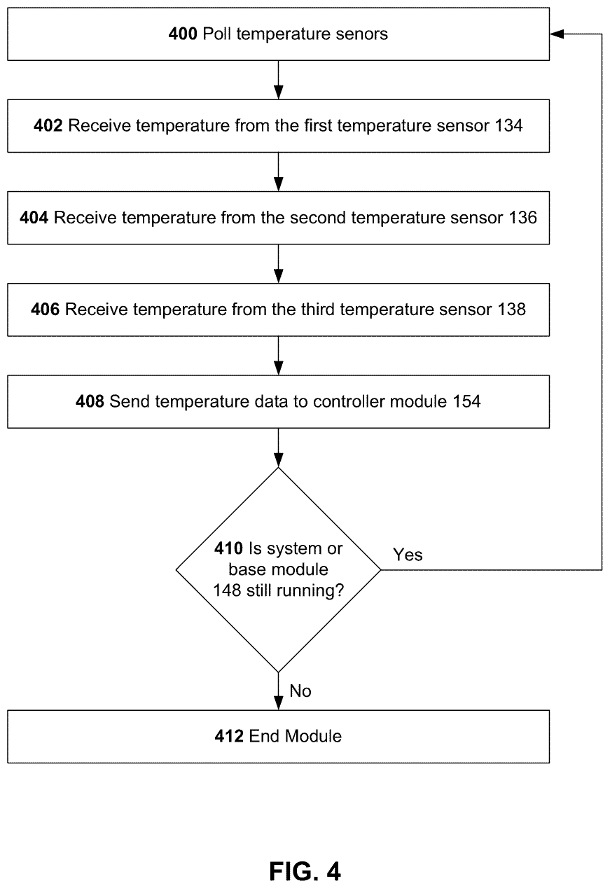

FIG. 4 illustrates a method for polling a temperature sensor. The process begins at step 400 with the temperature module polling the temperature sensors (134, 136, 138) for temperature data. At step 402, the temperature module 152 then receives temperature data from temperature sensor 134. The temperature module 152 then receives temperature data from the second temperature sensor 136 at step 404. The temperature module 152 then receives temperature data from the third temperature sensor 138 at step 406. In another embodiment, there may be more temperature sensors for receiving temperature data. In other embodiments, there may be fewer temperature sensors for receiving temperature data. Furthermore, it is well known in the art that sensor data can be collected simultaneously rather than in different steps. The above is to demonstrate one embodiment where data is collected separately from three temperature sensors (134, 136, 138) so that each area or zone around each temperature sensor (134, 136,138) may be controlled independently, and therefore should not be considered limiting to the scope of the present disclosure.

At step 408 after the temperature data is collected, the data is then sent directly to the controller module 154. The controller module 154 will then continuously compare the sent temperature data to previously user-inputted parameters.

At step 410, the temperature module 152 then checks to see if the system or blown film processes is still running or if the base module 148 is running. If one of the previous are not running, the module ends at step 412. If one of the previous are still running, then the system returns to step 400 and continues polling the temperature sensors (134, 136, 138).

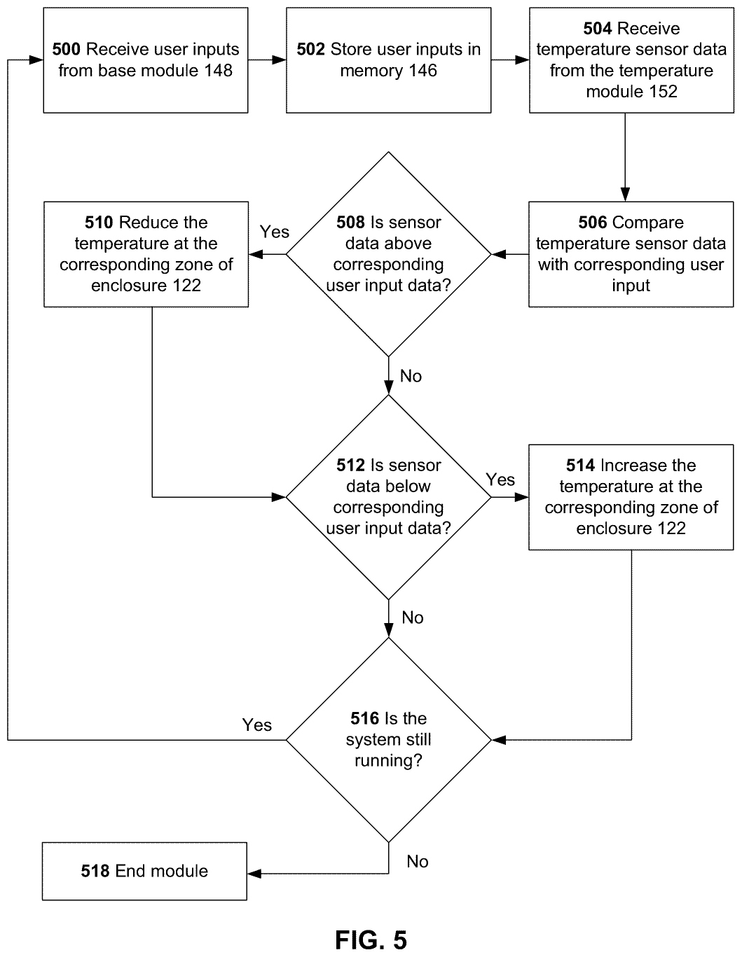

FIG. 5 illustrates a method for processing sensor data. The process begins at step 500 with the controller module 154 receiving the user inputs from the base module 148. The user inputs may include temperature ranges or parameters. The user inputs (i.e. temperature ranges) are used by the control module 154 to compare current temperature data collected by the temperature sensors (134, 136, 138) and to adjust the climate controller 124 accordingly to maintain the temperatures within the enclosure 122.

At step 502, if the user inputs that were previously received by the base module 148 have not already been stored in memory 146, the controller module 154 then stores them in memory 146 until the module ends so that the controller module 154 can reference the user inputs and compare them to the temperature data provided by the temperature sensors. In this embodiment, the user input data may include temperatures, temperature ranges, or parameters. There may be any number of temperature inputs from the user. For example, the embodiment shown in FIG. 1 has three temperature sensors (134, 136, 138) located at different places in the enclosure 122 or different zones of the enclosure 122. The controller module 154 then compares the user inputs (e.g., temperatures ranges) to temperature sensor data from each of the temperature sensors (134, 136, 138). The user may input ranges or parameters that correspond to each zone of the enclosure 122 and that correspond to the temperature sensor in each of the different zones.

At step 504, the controller module 154 then receives temperature data each of the three temperature sensors (134, 136, 138) from the temperature module 152. Temperature data from each of the different sensors corresponds to the general region or zone of the enclosure 122 where each of the temperatures sensors is located.

At step 506, the received temperatures from the temperature sensors (134, 136, 138) are then compared to the user inputs stored in memory 146. The sensor data is compared to the corresponding user input data. For example, in the embodiment shown in FIG. 1, the three temperature sensors (134, 136, 138) are each located at different places in the enclosure 122. Additionally, when a user inputs temperature ranges or parameters, the user may input parameters that correspond to each location or zone within the enclosure 122 where each of the temperature sensors (134, 136, 138) is located. For example, in one embodiment, the first temperature sensor 134 is located just after the air ring 110. The first temperature sensor 134 monitors the area or zone of the enclosure 122 within proximity of the sensor. Furthermore, the user may also input a temperature range or parameters that correspond to the zone that the first temperature sensor 134 monitors so that the controller module 154 can then compare the user inputted temperature for the zone with the actual temperature from the first temperature sensor 134. The same concepts apply to the second temperature sensor 136 and the third temperature sensor 138.

At step 508, the controller module 154 then determines if the temperature sensor data from each of the temperature sensors (134, 136, 138) is outside the temperature ranges or parameters inputted by the user. Specifically, in this step, the controller module 154 determines if the temperature is above the inputted ranges or parameters. If the temperature is not above the temperature range or parameters then the controller module 154 moves to step 512.

If the temperature is found to be above the inputted temperature ranges or parameters, then the controller module 154 moves to step 510, where the controller module 154 then reduces the temperature for the particular area(s) or zone(s) that are above the inputted ranges or parameters The controller module 154 may control the temperature in different areas or zones within the enclosure 122 by controlling the heating/cooling element 126, blowers 128, air vents 132, or a combination thereof. In such an embodiment, there may be a plurality of heating/cooling elements 126, blowers 128, air ducts 130, or air vents 132 that correspond to each of the different areas or zones within the enclosure 122. This configuration allows the controller module 154 to control each element of the system as needed to adjust the temperature until the temperature is brought back into the range or parameter inputted by the user. As an example, the controller module 154 may turn off the heating element or turn on a cooling element to lower the actual temperature as it is above the inputted range or parameter.

At step 512, the received temperatures from the user inputs are then compared to the temperature sensor data to determine whether the temperature sensor data is below the inputted temperature ranges or parameters. If the temperature data is not below the inputted ranges or parameters the controller module 154 moves to step 516.

If the temperature data from the temperature sensors (134, 136, 138) is below the inputted temperature ranges or parameters, the controller module 154 then adjusts the elements of the 124 climate controller accordingly to increase the temperature. This is similar to what is described above with respect to step 510, but elements would be adjusted to increase the temperature. For example, a heating element may be turned on or the temperature of the heating element may be increased while 128 blower or 132 air vents are adjusted to increase airflow, or a cooling element may be reduced or turned off.

Those having skill in the art will appreciate that steps 508 and 516 may be performed simultaneously or in reverse order (i.e., step 516 may be performed before step 508).

In another embodiment, rather than compare temperatures to a range of parameters, the controller module 154 may continuously monitor the temperature from the temperature sensors (134, 136, 138) and calculate the difference in the change in temperatures. The controller module 154 then adjusts the climate controller 124 temperature before temperatures are out of a set range. The “trending” parameters may provide better control to the controller module 154. For example, a temperature trend that in which the temperature moves up or down at a faster rate would require a larger change in the climate controller 124 to correct, whereas a temperature moving up or down more slowly would only require minor adjustments.

At step 516, the controller module 154 determines whether the system or process is still running. If it is still running the controller module 154 returns to step 500. If the system or process is not running, then the module ends at step 518.

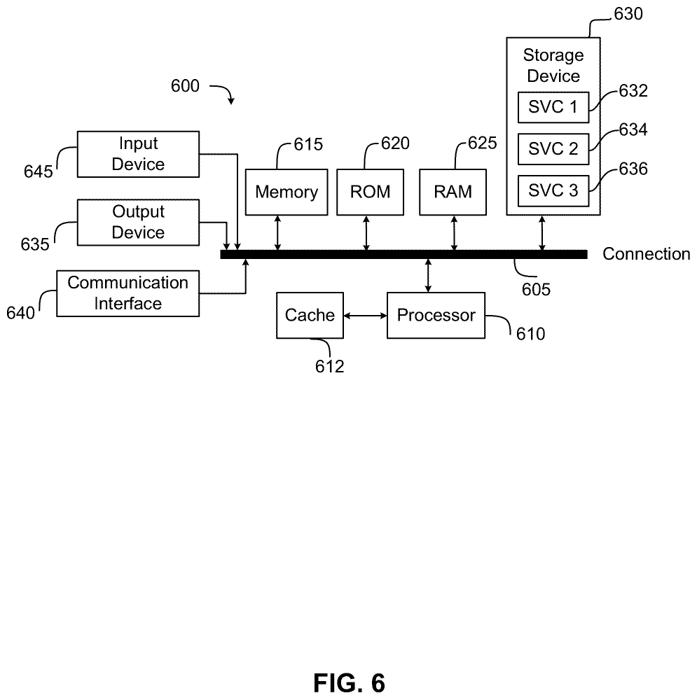

FIG. 6 illustrates an architecture of a computing system 600 wherein the components of the system 600 are in electrical communication with each other using a connection 605, such as a bus. System 600 includes a processing unit (CPU or processor) 610 and a system connection 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 910 to perform various actions. Other system memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable client interaction with the computing system 600, an input device 945 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a client to provide multiple types of input to communicate with the computing system 600. The communications interface 640 can generally govern and manage the client input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### ENUMERATED EMBODIMENTS

Embodiment 1: A system for producing a biopolymer blown film, the system comprising: an enclosure surrounding a biopolymer film bubble, the enclosure including one or more temperature sensors; and a climate controller in electrical communication with the one or more temperature sensors, the climate controller configured to increase or decrease a temperature within the enclosure.

Embodiment 2: The system of embodiment 1, wherein the enclosure further surrounds an air ring, the air ring operable to blow air into the biopolymer film bubble.

Embodiment 3: The system of embodiment 1 or embodiment 2, wherein the enclosure is insulated.

Embodiment 4: The system of any one of embodiments 1-3, wherein the enclosure further surrounds a collapsing frame within the enclosure and a plurality of primary nip rollers, wherein the collapsing frame and the plurality of primary nip rollers are located near a top of the enclosure and are operable to flatten the biopolymer film bubble into a double-thickness film.

Embodiment 5: The system of any one of embodiments 1-4, wherein the climate controller includes a heating element operable to heat air, a cooling element operable to cool air, or a combination thereof.

Embodiment 6: The system of embodiment 5, wherein the climate controller further includes a blower in fluid communication with one or more vents to provide heated air or cooled air to the enclosure.

Embodiment 7: The system of any one of embodiments 1-6, further comprising: a hopper in connection with an extruder operable to deliver biopolymer pellets to the extruder; the extruder operable to extrude the biopolymer through an annular die into the enclosure; and a biopolymer cooler operable to control the temperature of the extruded biopolymer prior to the formation of the biopolymer film bubble.

Embodiment 8: The system of embodiment 7, wherein the hopper further includes a dehumidifying element.

Embodiment 9: The system of embodiment 7, wherein the biopolymer cooler operates at a temperature from about 280° F. to about 450° F.

Embodiment 10: The system of any one of embodiments 1-9, the climate controller comprising a processor configured to: receive temperature data from the one or more temperature sensors; determine whether the temperature data is above or below one or more temperature parameters inputted by a user; and increase or decrease the temperature within the enclosure if the temperature data is above or below the one or more temperature parameters.

Embodiment 11: A process for producing a biopolymer blown film, the process comprising: blowing a biopolymer bubble in an enclosure, the enclosure comprising one or more temperature sensors operable to detect a temperature within the enclosure; comparing the detected temperature to a predetermined temperature; and increasing or decreasing the temperature of the enclosure when the detected temperature differs from the predetermined temperature.

Embodiment 12: A method for controlling the temperature in a system for producing a biopolymer blown film, the method comprising: inputting one or more temperature parameters corresponding to one or more zones in an enclosure of system; polling one or more temperature sensors for temperature data corresponding to the one or more zones; receiving the temperature data from the one or more temperature sensors; determining whether the temperature data is above or below the one or more temperature parameters; and outputting a control signal to increase or decrease the temperature of the one or more zones based on the temperature data.

What is claimed is:

1. A system for producing a biopolymer blown film, the system comprising:
an enclosure surrounding a biopolymer film bubble, the enclosure including one or more temperature sensors; and
a climate controller in electrical communication with the one or more temperature sensors, the climate controller configured to increase or decrease a temperature within the enclosure.

2. The system of claim 1, wherein the enclosure further surrounds an air ring, the air ring operable to blow air into the biopolymer film bubble.

3. The system of claim 1, wherein the enclosure is insulated.

4. The system of claim 1, wherein the enclosure further surrounds a collapsing frame within the enclosure and a plurality of primary nip rollers, wherein the collapsing frame and the plurality of primary nip rollers are located near a top of the enclosure and are operable to flatten the biopolymer film bubble into a double-thickness film.

5. The system of claim 1, wherein the climate controller includes a heating element operable to heat air, a cooling element operable to cool air, or a combination thereof.

6. The system of claim 5, wherein the climate controller further includes a blower in fluid communication with one or more vents to provide heated air or cooled air to the enclosure.

7. The system of claim 1, further comprising:
a hopper in connection with an extruder operable to deliver biopolymer pellets to the extruder;
the extruder operable to extrude the biopolymer through an annular die into the enclosure; and
a biopolymer cooler operable to control the temperature of the extruded biopolymer prior to the formation of the biopolymer film bubble.

8. The system of claim 7, wherein the hopper further includes a dehumidifying element.

9. The system of claim 7, wherein the biopolymer cooler operates at a temperature from about 280° F. to about 450° F.

10. The system of claim 1, the climate controller comprising a processor configured to:
receive temperature data from the one or more temperature sensors;
determine whether the temperature data is above or below one or more temperature parameters inputted by a user; and
increase or decrease the temperature within the enclosure if the temperature data is above or below the one or more temperature parameters.

11. A process for producing a biopolymer blown film, the process comprising:
blowing a biopolymer bubble in an enclosure, the enclosure comprising one or more temperature sensors operable to detect a temperature within the enclosure;
comparing the detected temperature to a predetermined temperature; and
increasing or decreasing the temperature of the enclosure when the detected temperature differs from the predetermined temperature.

12. A method for controlling the temperature in a system for producing a biopolymer blown film, the method comprising:
inputting one or more temperature parameters corresponding to one or more zones in an enclosure of system;
polling one or more temperature sensors for temperature data corresponding to the one or more zones;
receiving the temperature data from the one or more temperature sensors;
determining whether the temperature data is above or below the one or more temperature parameters; and
outputting a control signal to increase or decrease the temperature of the one or more zones based on the temperature data.
